(19) United States
(12) Patent Application Publication
(10) Pub. No.: US 2020/0013557 A1
(43) Pub. Date: Jan. 9, 2020

(54) ELECTROLYTIC CAPACITOR

(71) Applicant: Panasonic Intellectual Property Management Co., Ltd., Osaka (JP)

(72) Inventors: TAKAYUKI MATSUMOTO, Saga (JP); HONAMI NISHINO, Osaka (JP); SHIN FUJITA, Yamaguchi (JP); TOMOYUKI TASHIRO, Yamaguchi (JP); MASATO MORI, Hyogo (JP); HIROHISA HINO, Osaka (JP)

(21) Appl. No.: 16/574,511

(22) Filed: Sep. 18, 2019

Related U.S. Application Data
(63) Continuation of application No. PCT/JP2018/011967, filed on Mar. 26, 2018.

(30) Foreign Application Priority Data
Mar. 31, 2017 (JP) 2017-071831

(51) Int. Cl. H01G 9/08; H01G 2/10; H01G 2/08

(52) U.S. Cl. CPC H01G 9/08; H01G 2/08; H01G 2/10

(57) ABSTRACT

An electrolytic capacitor includes a capacitor element, a case housing the capacitor element, and a first heat radiation layer having an insulating property. The first heat radiation layer covers at least part of the capacitor element. A thermal conductivity λ_{C} of the case in a thickness direction is greater than or equal to 1 W/m·K. A thermal emissivity ε₁ of the first heat radiation layer is greater than or equal to 0.7.

### RELATED APPLICATIONS

This application is a continuation of the PCT International Application No. PCT/JP2018/011967 filed on Mar. 26, 2018, which claims the benefit of foreign priority of Japanese patent application No. 2017-071831 filed on Mar. 31, 2017, the contents all of which are incorporated herein by reference.

### BACKGROUND

### 1. Technical Field

The present disclosure relates to an electrolytic capacitor, and particularly to the electrolytic capacitor having improved heat radiation property.

### 2. Description of the Related Art

When an alternating-current (AC) voltage is applied to an electrolytic capacitor, AC charge or discharge current (ripple current) flows in the electrolytic capacitor. Since a capacitor element included in the electrolytic capacitor has internal resistance called the equivalent series resistance (ESR), the ripple current causes the electrolytic capacitor to generate heat. The generated heat causes deterioration of the capacitor element and thus may make a long-term use of the electrolytic capacitor difficult. Against this problem, measures for heat radiation have been taken, such as formation of a heat radiation coating layer on a surface of a case of an electrolytic capacitor (see, for example, Unexamined Japanese Patent Publication No. 2012-64842).

### SUMMARY

An electrolytic capacitor according to the present disclosure includes a capacitor element, a case housing the capacitor element, and a first heat radiation layer having an insulating property. The first heat radiation layer covers at least part of the capacitor element. A thermal conductivity λ_{C} of the case in a thickness direction is greater than or equal to 1 W/m·K. A thermal emissivity ε₁ of the first heat radiation layer is greater than or equal to 0.7.

According to the present disclosure, heat generated from the capacitor element is likely to be radiated to outside the case. This can allow the electrolytic capacitor to attain a long lifetime and be designed for a high level of ripple current.

### BRIEF DESCRIPTION OF THE DRAWINGS

FIG. 1 is a schematic cross-sectional view illustrating an example of an electrolytic capacitor according to a first exemplary embodiment of the present disclosure;

FIG. 2 is a schematic cross-sectional view illustrating an example of an electrolytic capacitor according to a second exemplary embodiment of the present disclosure;

FIG. 3 is a schematic cross-sectional view illustrating an example of an electrolytic capacitor according to a third exemplary embodiment of the present disclosure;

FIG. 4 is a schematic cross-sectional view illustrating an example of an electrolytic capacitor according to a fourth exemplary embodiment of the present disclosure;

FIG. 5 is a schematic cross-sectional view illustrating an example of an electrolytic capacitor according to a fifth exemplary embodiment of the present disclosure; and

FIG. 6 is a schematic view illustrating a configuration of a capacitor element according to an exemplary embodiment of the present disclosure.

### DETAILED DESCRIPTION OF EMBODIMENT

A heat radiation effect produced only by a heat radiation layer disposed on a surface of a case of an electrolytic capacitor, as is disclosed in Unexamined Japanese Patent Publication No. 2012-64842, is not satisfactory.

An electrolytic capacitor according to an exemplary embodiment of the present disclosure includes a capacitor element, a case housing the capacitor element, and a first heat radiation layer having an insulating property. The first heat radiation layer covers at least part of the capacitor element. A thermal conductivity λ_{C} of the case in a thickness direction is greater than or equal to 1 W/m·K. A thermal emissivity ε₁ of the first heat radiation layer is greater than or equal to 0.7. It is noted that the thermal conductivity of the case in the thickness direction described herein represents a thermal conductivity of a case in a direction extending from an inner surface of the case to an outer surface of the case.

A thermal emissivity ε of a material is a ratio of an amount of the heat radiation from the material to an amount of the heat radiation from a black body, which is a virtual substance. Thermal emissivity ε is mathematically equivalent to thermal absorptivity α. In other words, a material with a high thermal emissivity ε has a high thermal absorptivity α. Hence, in the electrolytic capacitor according to the exemplary embodiment of the present disclosure, heat generated from the capacitor element is quickly absorbed into the first heat radiation layer, which has high thermal emissivity, and is efficiently radiated to the case. After that, the heat is efficiently transferred to outside the case, which has high thermal conductivity in the thickness direction. Accordingly, this configuration allows the electrolytic capacitor to attain a long lifetime and be designed for a high level of ripple current.

### (Case)

A capacitor element is housed in a case having a bottomed shape and a hollow structure, for example. A thermal conductivity λ_{C} of the case in a thickness direction is greater than or equal to 1 W/m·K, and preferably greater than or equal to 2 W/m·K. This improves thermal conduction from an inside to an outside of the case.

A material for the case is not particularly limited. Examples of the material for the case include resins (e.g. epoxy resins, phenol resins, polyester resins, melamine resins, polyimide resins), metals (e.g. aluminum, iron, stainless steel), and ceramics (e.g. aluminum oxide, zirconium dioxide, aluminum nitride, silicon nitride). When the case is formed by using a material such as a resin with thermal conductivity λ_{C} of less than 1 W/m·K in the thickness direction, the material is preferably mixed with a filler having high thermal conductivity (hereinafter referred to as a first thermal conductive filler). The first thermal conductive filler is any material such as silver, copper, graphite, silicon carbide, aluminum oxide, boron nitride, and aluminum nitride, for example. The filler may be used in any single substance of these or a combination of two or more of these substances.

A shape of the first thermal conductive filler is not particularly limited. However, it is preferred that pieces of the filler are in contact with each other and thereby efficiently transfer heat through them to improve the thermal conductivity in the thickness direction. Thus, the thermal conductive filler preferably has a particle shape. The particle shape is, for example, a shape with an aspect ratio of 1 or greater and less than 2. A thermal conductive filler with a high aspect ratio and a thermal conductive filler with a low aspect ratio may be used in combination. This allows particles of the thermal conductive filler to be filled most densely in the material.

An average particle diameter of the first thermal conductive filler is not particularly limited, but ranges from 1 μm to 50 μm, inclusive, for example. The average particle diameter is a particle diameter (D50) at which the cumulative volume of particles reaches 50% in a volume particle size distribution (the same shall apply hereinafter). The average particle diameter D50 is measured by, for example, a laser diffraction scattering method using a laser diffraction particle size distribution measuring apparatus.

An outer surface of the case that does not face the capacitor element may be covered with a resin film. Information such as a product number, a model name, and a manufacturer name may be described on the resin film by printing, sealing, or another technique as needed.

In general, the resin film has a low thermal conductivity (e.g. 0.1 W/m·K) although the resin film has moderate degree of thermal emissivity (e.g. 0.6 to 0.7). Even if the case is covered with such a resin film, radiation of heat generated from the capacitor element to outside the case can be improved because the case has high thermal conductivity λ_{C} in the thickness direction, and a first heat radiation layer with excellent thermal emissivity ε is disposed adjacent to the case. As described later, when at least one of a first heat radiation layer, a second heat radiation layer, and a thermal conductive layer is disposed on the outer surface of the case, the resin film is disposed outside the above-described layer disposed on the outer surface of the case.

### (First Heat Radiation Layer)

A first heat radiation layer is disposed on an inner surface of the case, the outer surface of the case, or a surface of the capacitor element, to cover at least part of the capacitor element. The first heat radiation layer may be disposed on the inner surface of the case, which faces the capacitor element, to cover at least part of the inner surface of the case. The first heat radiation layer may be disposed on the surface of the capacitor element to cover at least part of the surface of the capacitor element. The first heat radiation layer may be disposed on the outer surface of the case to cover at least part of the outer surface of the case. Preferably, the first heat radiation layer is disposed on and is in contact with the inner surface of the case and/or the surface of the capacitor element in terms of efficient absorption of heat generated from the capacitor element.

Thermal emissivity ε₁ of the first heat radiation layer is preferably greater than or equal to 0.7, and more preferably greater than or equal to 0.85. This allows heat generated from the capacitor element to be quickly absorbed into the first heat radiation layer and be efficiently radiated to the case. Thermal emissivity ε₁ is less than or equal to 1.

The first heat radiation layer, for example, includes a filler having insulating and heat radiation properties (hereinafter referred to as a first heat radiation filler) and a binder having an insulating property (hereinafter referred to as a first binder).

Examples of the first heat radiation filler include ceramics such as zinc oxide, silicon oxide, magnesium oxide, titanium oxide, and iron oxide, and natural or artificial minerals such as enstatite (MgO.SiO₂), cliopside (CaO.MgO.2SiO₂), forsterite (2Mg₂.SiO₄), zircon (ZrO₂.SiO₂), cordierite (2MgO.2Al₂O₃.5SiO), hydrotalcite (Mg₆Al₂(OH)₁₆CO₃.4H₂O), steatite (MgO.SiO₂), mullite (3Al₂O₃.2SiO₂), spodumene (Li₂O.Al₂O₃.SiO₂), wollastonite (CaSiO₃), anorthite (CaAl₂Si₂O₈), albite (NaAlSi₃O₈), willemite, and petalite. The filler may be used in any single substance of these or a combination of two or more of these substances. The first heat radiation filler preferably contain at least one element selected from the group consisting of aluminum, magnesium, and silicon, and more preferably contain all these elements in terms of superiority in heat radiation property. Specifically, cordierite is preferable. An average particle diameter of the first heat radiation filler is not particularly limited, but ranges from 1.0 μm to 50 μm, inclusive, for example.

The first binder is not particularly limited. Examples of the first binder include thermoplastic resins such as polyolefin resins (e.g. polyethylene resin, polypropylene resin, and polymethylpentene resin), polyester resins (e.g. polyethylene terephthalate resin and polybutylene terephthalate resin), polycarbonate resins, polyarylate resins, polyether ketone resins, and silicone resins, and thermosetting resins such as acrylic resins, epoxy resins, oxetane resins, cyanate resins, phenol resins, and resole resins. The binder may be any single substance of these or a combination of two or more of these substances. The first binder preferably is an epoxy resin or a silicone resin in terms of superiority in heat resistance.

An amount of the first heat radiation filler contained in the first heat radiation layer is not particularly limited. However, a content proportion of the first heat radiation filler is preferably greater than or equal to 50% by mass, and more preferably greater than or equal to 70% by mass from the viewpoint of heat radiation performance. Meanwhile, the content proportion of first heat radiation filler is preferably less than or equal to 95% by mass, and more preferably less than or equal to 85% by mass from the viewpoint of strength of the first heat radiation layer.

A thickness of the first heat radiation layer is not particularly limited. However, when the first heat radiation layer has an excessively thin thickness, the first heat radiation layer is affected by heat reflectivity of the surface of the case or the capacitor element on which the first heat radiation layer is disposed. This may hinder to sufficiently exhibit the effect of the first heat radiation layer. A material having a metallic luster generally has high heat reflectivity and low thermal emissivity. Hence, when the first heat radiation layer is, for example, disposed on an inner surface of a case, which has a metallic luster, heat that has been absorbed into the first heat radiation layer and been radiated to the case is likely to be reflected by the inner surface of the case. Thus, it may be difficult for the heat to be emitted to outside the case. In consideration of this respect, the thickness of the first heat radiation layer is preferably greater than or equal to 10 μm, and more preferably greater than or equal to 30 μm. Meanwhile, from the viewpoint of miniaturization of an electrolytic capacitor, the thickness of the first heat radiation layer is preferably less than or equal to 200 μm, and more preferably less than or equal to 100 μm.

The first heat radiation layer preferably has thermal conductivity, and more preferably has high thermal conductivity in the thickness direction. This configuration allows heat that has been absorbed in the first heat radiation layer to be radiated and conducted to the case, and thus further improves performance of radiation of heat to outside the case. In this instance, it is more preferred that the first heat radiation layer is in contact with the case. A thermal conductivity λ₁ of the first heat radiation layer in the thickness direction is preferably greater than or equal to 1 W/m·K, and more preferably greater than or equal to 2 W/m·K. This provides an improvement in thermal conduction to the case.

### (Second Heat Radiation Layer)

Preferably, the electrolytic capacitor includes a second heat radiation layer having an insulating property, in addition to the first heat radiation layer. Preferably, the second heat radiation layer is disposed so as to face the first heat radiation layer with the case interposed between these two layers. This allows heat generated from the capacitor element to be radiated with improved efficiency. When the first heat radiation layer is disposed on, for example, the inner surface of the case, it is preferred that the second heat radiation layer is disposed on an outer surface of the case opposite the inner surface so as to cover at least part of the outer surface of the case. Similarly, when the first heat radiation layer is disposed on the surface of the capacitor element, it is preferred that the second heat radiation layer is disposed on the outer surface of the case so as to cover at least part of the outer surface of the case.

Thermal emissivity ε₂ of the second heat radiation layer is not particularly limited, but is preferably greater than or equal to 0.7, and more preferably greater than or equal to 0.85 from the viewpoint of heat radiation performance. Thermal emissivity ε₂ is less than or equal to 1. A configuration of the second heat radiation layer is not particularly limited, but may be similar to that of the first heat radiation layer. A thickness of the second heat radiation layer may be identical to that of the first heat radiation layer.

The second heat radiation layer preferably has thermal conductivity, and more preferably has high thermal conductivity in the thickness direction. A thermal conductivity λ₂ of the second heat radiation layer in the thickness direction is preferably greater than or equal to 1 W/m·K, and more preferably greater than or equal to 2 W/m·K.

### (Thermal Conductive Layer)

The electrolytic capacitor may include a thermal conductive layer in addition to the first heat radiation layer. The thermal conductive layer is disposed on and is in contact with the inner surface or the outer surface of the case so as to at least partly cover the inner surface or the outer surface of the case. This provides an improvement in thermal conduction from the inside to the outside of the case, and further improves heat radiation performance.

When the first heat radiation layer is disposed on, for example, the inner surface of the case, the thermal conductive layer may be disposed between the first heat radiation layer and the case or may be disposed on the outer surface of the case. Preferably, the thermal conductive layer is disposed between the first heat radiation layer and the case (fourth exemplary embodiment) in terms of facilitation of lowering the temperature inside the case. This applies similarly to a case in which the first heat radiation layer is disposed on the surface of the capacitor element.

A thermal conductivity λ_{L} of the thermal conductive layer in the thickness direction is preferably greater than or equal to a thermal conductivity λ₁ of the first heat radiation layer in the thickness direction. The thermal conductivity λ_{L} is preferably greater than or equal to 1 W/m·K, and more preferably greater than or equal to 2 W/m·K in terms of further improvement in thermal conduction from the inside to the outside of the case.

The thermal conductive layer, for example, includes a thermal conductive filler (hereinafter referred to as a second thermal conductive filler) and a binder (hereinafter referred to as a second binder). Examples of the second thermal conductive filler are the same as those of the first thermal conductive filler. The second thermal conductive filler preferably is silicon carbide in terms of superiority in thermal conductivity. An average particle diameter of the second thermal conductive filler is not particularly limited, but ranges from 5 μm to 50 μm, inclusive, for example. The second binder is not particularly limited. Examples of the second binder include resins similar to those for the first binder. The second binder is preferably an epoxy resin or a silicone resin in terms of superiority in heat resistance.

A content proportion of the second thermal conductive filler in the thermal conductive layer is not particularly limited. However, the content proportion of the second thermal conductive filler is greater than or equal to 50% by mass, and more preferably greater than or equal to 60% by mass from the viewpoint of thermal conductivity. Meanwhile, the content proportion of the second thermal conductive filler is less than or equal to 95% by mass, and more preferably be less than or equal to 90% by mass from the viewpoint of strength of the thermal conductive layer.

A thickness of the thermal conductive layer is not particularly limited, but is preferably greater than or equal to 10 μm, and more preferably greater than or equal to 30 μm from the viewpoint of thermal conductivity. Meanwhile, from the viewpoint of miniaturization of an electrolytic capacitor, the thickness of the thermal conductive layer is preferably less than or equal to 200 μm, and more preferably less than or equal to 100 μm.

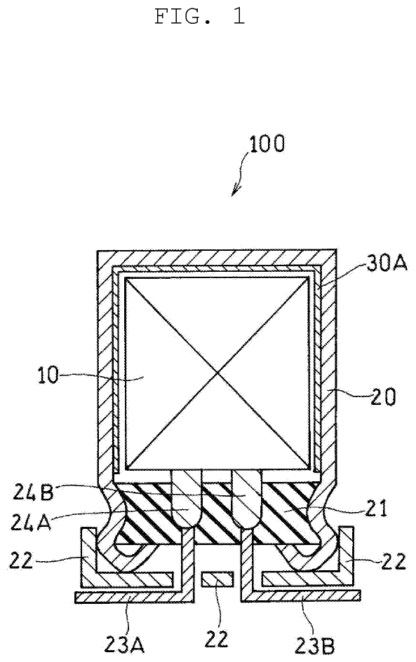

Exemplary embodiments will now be described in detail with reference to the drawings. FIGS. 1 to 5 are schematic cross-sectional views illustrating electrolytic capacitors 100 according to the exemplary embodiments. However, a configuration of electrolytic capacitor 100 is not limited to these examples.

### First Exemplary Embodiment

As shown in FIG. 1, electrolytic capacitor 100 according to a first exemplary embodiment includes capacitor element 10, case 20 housing the capacitor element, and first heat radiation layer 30A having an insulating property. First heat radiation layer 30A is disposed on an inner surface of case 20, which faces capacitor element 10, such that first heat radiation layer 30A covers at least part of the inner surface of the case.

Such electrolytic capacitor 100 is manufactured, for example, as described below. First, a plate-shaped substance, which is a material for case 20, is coated with a material of first heat radiation layer 30A (e.g. a mixture of a first heat radiation filler and a first binder) or is stacked with a sheet material formed from the heat radiation layer material described above to acquire a stack body. The acquired stack body is molded into a shape of case 20 such that first heat radiation layer 30A is disposed inside. After that, capacitor element 10 is housed in case 20. When case 20 is made of a metallic material, case 20 is molded by drawing, for example. When the material of first heat radiation layer 30A contains a thermosetting resin, case 20 is heated after molding of case 20 to cure the thermosetting resin. Case 20 may be heated either before or after capacitor element 10 is housed.

First heat radiation layer 30A having high thermal emissivity ε is disposed so as to face capacitor element 10 that acts as a heat source. Thus, heat generated from capacitor element 10 is quickly absorbed into first heat radiation layer 30A. Further, first heat radiation layer 30A is formed on an inner surface of case 20 that has high thermal conductivity λ in a thickness direction. Hence, heat absorbed into first heat radiation layer 30A is quickly conducted from the inner surface to an outer surface of case 20, and is emitted to outside electrolytic capacitor 100.

Electrolytic capacitor 100 further includes sealing body 21 to close an opening of case 20, base plate 22 to cover sealing body 21, lead wires 23A, 23B protruding from sealing body 21 to pass through base plate 22, and lead tabs 24A, 24B to connect the lead wires with respective electrodes of capacitor element 10. Case 20 is, at its part near an end of the opening, processed inward by drawing, and the opening end is curled to swage sealing body 21. Electrolytic capacitor 100 further includes an electrolyte that is housed in case 20 in addition to capacitor element 10.

### Second Exemplary Embodiment

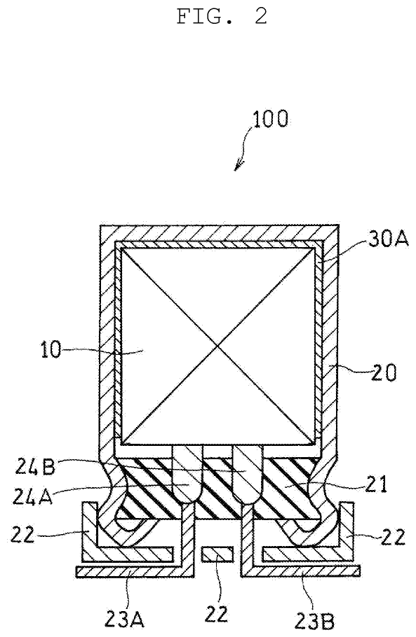

As shown in FIG. 2, electrolytic capacitor 100 according to a second exemplary embodiment is similar to the electrolytic capacitor of the first exemplary embodiment except that first heat radiation layer 30A having an insulating property is disposed on a surface of capacitor element 10 to cover at least part of the surface of capacitor element 10. In this case, it is preferred that first heat radiation layer 30A is in contact with case 20 in terms of improvement in thermal conduction from first heat radiation layer 30A to case 20.

Such electrolytic capacitor 100 is manufactured, for example, as described below. A material of first heat radiation layer 30A is coated on the surface of capacitor element 10, or a sheet material formed from the heat radiation layer material described above is thermally melted to bond the melted sheet material to the surface of the capacitor element. After that, the capacitor element is housed in case 20. When the material of first heat radiation layer 30A contains a thermosetting resin, capacitor element 10 is heated to cure the thermosetting resin after the surface of capacitor element 10 is covered with the material of first heat radiation layer 30A. Capacitor element 10 may be heated either before or after capacitor element 10 is housed in case 20.

Since first heat radiation layer 30A is in contact with capacitor element 10, heat generated from capacitor element 10 is absorbed in first heat radiation layer 30A more quickly. In addition, first heat radiation layer 30A is disposed so as to face case 20 that excels in thermal conductivity λ in a thickness direction. Hence, heat absorbed in first heat radiation layer 30A is quickly conducted from an inner surface to an outer surface of case 20, and is emitted to outside electrolytic capacitor 100.

### Third Exemplary Embodiment

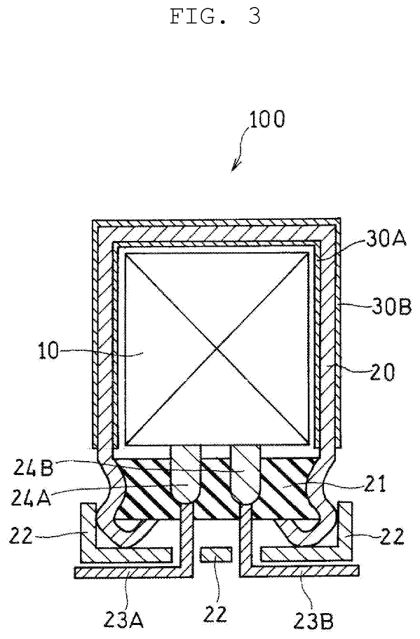

As shown in FIG. 3, electrolytic capacitor 100 according to a third exemplary embodiment is similar to the electrolytic capacitor of the first exemplary embodiment except that electrolytic capacitor 100 includes second heat radiation layer 30B disposed on an outer surface of case 20 to cover at least part of the outer surface of the case in addition to first heat radiation layer 30A disposed on an inner surface of case 20.

Such electrolytic capacitor 100 is manufactured, for example, as described below. A first surface of a plate-shaped substance, which is a material for case 20, is coated with a material of first heat radiation layer 30A or is stacked with a sheet material formed from the heat radiation layer material described above. Then, a second surface of the plate-shaped substance is coated with a material of second heat radiation layer 30B or is stacked with a sheet material formed from the heat radiation layer material described above to acquire a stack body. The acquired stack body is molded into a shape of case 20 such that first heat radiation layer 30A is disposed inside. After that, capacitor element 10 is housed in case 20. Alternatively, after making of case 20 with first heat radiation layer 30A disposed on an inner surface of the case using a method similar to that in the first exemplary embodiment, an outer surface of case 20 may be coated with a material of second heat radiation layer 30B. When the material of first heat radiation layer 30A and/or the material of second heat radiation layer 30B contain a thermosetting resin, case 20 is heated after molding of case 20 to cure the thermosetting resin. Case 20 may be heated either before or after capacitor element 10 is housed.

In the present exemplary embodiment, first heat radiation layer 30A and second heat radiation layer 30B face each other via case 20. Heat generated from capacitor element 10 is quickly absorbed into first heat radiation layer 30A that is disposed so as to face capacitor element 10 that acts as a heat source. Heat absorbed into first heat radiation layer 30A is quickly conducted from the inner surface to the outer surface of case 20. Since second heat radiation layer 30B having high thermal emissivity is disposed on the outer surface of case 20, heat is more readily conducted in a thickness direction of case 20. Heat conducted to the outer surface of case 20 is efficiently radiated to outside case 20 through second heat radiation layer 30B.

### Fourth Exemplary Embodiment

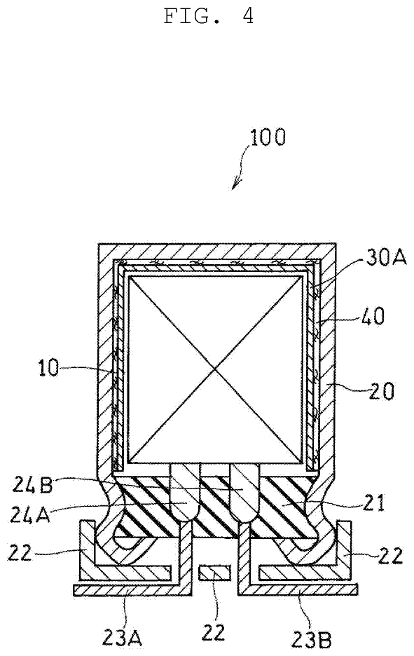

As shown in FIG. 4, electrolytic capacitor 100 according to a fourth exemplary embodiment is similar to the electrolytic capacitor of the first exemplary embodiment except that electrolytic capacitor 100 includes thermal conductive layer 40 disposed to be in contact with an inner surface of case 20 to be disposed between first heat radiation layer 30A and case 20.

Such electrolytic capacitor 100 is manufactured, for example, as described below. A first surface of a plate-shaped substance, which is a material for case 20, is coated with a material of thermal conductive layer 40 (e.g. a mixture of a second thermal conductive filler and a second binder) or is stacked with a sheet material formed from the thermal conductive layer material described above. Then, a surface of the coated or stacked material is coated with a material of first heat radiation layer 30A or is stacked with a sheet material formed from the heat radiation layer material described above to acquire a stack body. The acquired stack body is molded into a shape of case 20 such that first heat radiation layer 30A is disposed inside. After that, capacitor element 10 is housed in case 20. When the material of first heat radiation layer 30A and/or the material of thermal conductive layer 40 contain a thermosetting resin, case 20 is heated after molding of case 20 to cure the thermosetting resin. Case 20 may be heated either before or after capacitor element 10 is housed.

First heat radiation layer 30A having high thermal emissivity ε (thermal absorptivity α) is disposed so as to face capacitor element 10 that acts as a heat source. Thus, heat generated from capacitor element 10 is quickly absorbed in first heat radiation layer 30A. Thermal conductive layer 40 is in contact with the inner surface of case 20 and is disposed so as to cover at least part of the inner surface of the case. As a result, heat absorbed in first heat radiation layer 30A is quickly conducted from thermal conductive layer 40 to the inner surface of case 20 and to an outer surface of case 20, and is emitted to outside electrolytic capacitor 100. In a similar way to this, heat is conducted in a case in which thermal conductive layer 40 is disposed so as to be in contact with the outer surface of case 20.

### Fifth Exemplary Embodiment

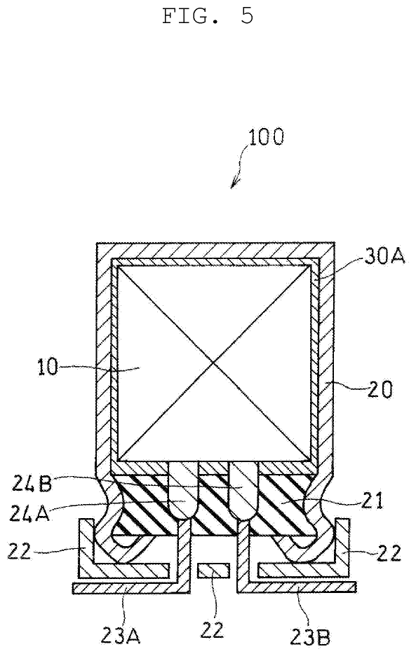

As shown in FIG. 5, electrolytic capacitor 100 according to a fifth exemplary embodiment is similar to the electrolytic capacitor of the first exemplary embodiment except that first heat radiation layer 30A having an insulating property is disposed on capacitor element 10 to cover entirety of a surface of capacitor element 10.

Such electrolytic capacitor 100 is manufactured, for example, as described below. Capacitor element 10 is housed in case 20, and then case 20 is filled with a material of first heat radiation layer 30A. If the material of first heat radiation layer 30A contains a thermosetting resin, case 20 is heated to cure the thermosetting resin after the material of first heat radiation layer 30A fills case 20. This method enables readily forming of first heat radiation layer 30A that entirely covers the surface of capacitor element 10 and that is in contact with case 20. In addition, by this method, first heat radiation layer 30A is formed so as to fill a gap between case 20 and capacitor element 10. This further improves heat radiation performance.

Since first heat radiation layer 30A covers entirety of the surface of capacitor element 10, heat generated from capacitor element 10 is absorbed in first heat radiation layer 30A more quickly. In addition, first heat radiation layer 30A is in contact with case 20 that excels in thermal conductivity λ in a thickness direction. Hence, heat absorbed in first heat radiation layer 30A is quickly conducted from an inner surface to an outer surface of case 20, and is emitted to outside electrolytic capacitor 100.

### (Capacitor Element)

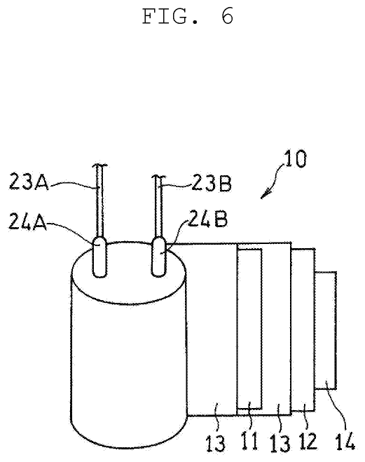

A capacitor element according to any of the exemplary embodiments will now be described with reference to the drawings. FIG. 6 is a schematic view illustrating development of a part of capacitor element 10. However, a configuration of capacitor element 10 is not limited to this example.

Capacitor element 10, for example, includes foil-shaped anode 11, foil-shaped cathode 12, and separator 13 disposed between the anode and the cathode. Anode 11 and cathode 12 with separator 13 disposed between them are wound to form a wound body. An outermost periphery of the wound body is fixed with fastening tape 14. Anode 11 is connected to lead tab 24A, and cathode 12 is connected to lead tab 24B. Capacitor element 10 may be a laminated capacitor element having a stack of anode 11 and cathode 12 with separator 13 disposed between them.

Capacitor element 10 may include a sintered body (porous body) containing a valve metal as an anode body. When the sintered body is used, an end of an anode lead is embedded in the sintered body. Such a capacitor element, for example, includes the anode body described above, a dielectric layer covering the anode body, and a cathode part covering the dielectric layer. The cathode part, for example, includes a solid electrolyte layer covering the dielectric layer and a cathode lead-out layer covering the solid electrolyte layer.

### (Anode)

Anode 11, for example, includes an anode body and a dielectric layer covering the anode body. The anode body may include a valve metal, an alloy containing a valve metal, and a compound containing a valve metal. The anode body may be any single substance of these or a combination of two or more of these substances. Preferable examples of the valve metal include aluminum, tantalum, niobium, and titanium. The anode body has a porous surface. Such an anode body can be obtained by, for example, roughening a surface of a base material (such as a foil-shaped or plate-shaped base material) including a valve metal by etching or other processing.

The dielectric layer contains an oxide of the valve metal (such as aluminum oxide or tantalum oxide). The dielectric layer is formed along a porous surface (including inner wall faces of holes) of the anode body.

The dielectric layer is, for example, formed by anodizing a surface of the anode body through an anodizing treatment or the like. Anodizing can be performed by a publicly known method, for example, an anodizing treatment. The anodizing treatment can, for example, involve immersing the anode body in an anodizing solution to impregnate the surface of the anode body with the anodizing solution and applying a voltage between the anode body as an anode and a cathode immersed in the anodizing solution.

### (Cathode)

Cathode 12 is not particularly limited, with proviso that cathode 12 functions as a cathode. Cathode 12 is, for example, formed of a valve metal, an alloy containing a valve metal, or a compound containing a valve metal in a similar way to anode 11. A surface of cathode 12 may be roughened as necessary.

### (Separator)

For separator 13, for example, the following is preferably used: a nonwoven fabric made of cellulose fiber, a nonwoven fabric made of glass fiber, a microporous membrane made of polyolefin, a fabric cloth, or a nonwoven fabric. Separator 13 has a thickness ranging, for example, from 10 μm to 300 μm, inclusive, preferably from 10 μm to 60 μm, inclusive.

### (Electrolyte)

It is possible to use, as the electrolyte, an electrolytic solution, a solid electrolyte, or both.

The electrolytic solution may be a non-aqueous solvent or a mixture of a non-aqueous solvent and an ionic material (a solute, for example, an organic salt) dissolved in the non-aqueous solvent. The non-aqueous solvent may be an organic solvent or an ionic liquid. It is possible to use, as the non-aqueous solvent, for example, ethylene glycol, propylene glycol, sulfolane, γ-butyrolactone, or N-methylacetamide. Examples of the organic salts include trimethylamine maleate, triethylamine borodisalicylate, ethyldimethylamine phthalate, mono 1,2,3,4-tetramethylimidazolinium phthalate, and mono 1,3-dimethyl-2-ethylimidazolinium phthalate.

The solid electrolyte, for example, contains a manganese compound and a conductive polymer. Examples of the conductive polymer include polypyrrole, polythiophene, polyaniline, and derivatives of them. The solid electrolyte layer may contain a dopant. More specifically, the solid electrolyte layer may contain poly (3,4-ethylenedioxythiophene) (PEDOT) as a conductive polymer and polystyrene sulfonic acid (PSS) as a dopant.

The solid electrolyte containing the conductive polymer can be formed by, for example, chemical polymerization and/or electropolymerization of a raw material monomer on the dielectric layer formed on the anode body. Alternatively, the solid electrolyte can be formed by coating the dielectric layer with a solution in which the conductive polymer is dissolved or a dispersion liquid in which the conductive polymer is dispersed. Forming of the solid electrolyte is satisfactory as long as the solid electrolyte is disposed between anode 11 and cathode 12. Thus, the solid electrolyte may be formed by impregnating a wound body formed of wound anode 11, separator 13, and cathode 12 with a raw material monomer or a treatment solution containing the conductive polymer.

An electrolytic capacitor according to the present disclosure excels in heat radiation performance and thus can find various applications.

What is claimed is:

1. An electrolytic capacitor comprising:
a capacitor element;
a case housing the capacitor element; and
a first heat radiation layer having an insulating property, the first heat radiation layer covering at least part of the capacitor element, wherein:
a thermal conductivity λ_{C} of the case in a thickness direction is greater than or equal to 1 W/m·K, and
a thermal emissivity ε₁ of the first heat radiation layer is greater than or equal to 0.7.

2. The electrolytic capacitor according to claim 1, wherein the first heat radiation layer is disposed on an inner surface of the case to cover at least part of the inner surface of the case, the inner surface of the case facing the capacitor element.

3. The electrolytic capacitor according to claim 1, wherein the first heat radiation layer is disposed on a surface of the capacitor element to cover at least part of the surface of the capacitor element.

4. The electrolytic capacitor according to claim 1, further comprising a second heat radiation layer having an insulating property, wherein:
a thermal emissivity ε₂ of the second heat radiation layer is greater than or equal to 0.7, and
the second heat radiation layer is disposed on an outer surface of the case to cover at least part of the outer surface of the case, the outer surface of the case being opposite to an inner surface of the case, the inner surface of the case facing the capacitor element.

5. The electrolytic capacitor according to claim 1, further comprising a thermal conductive layer, wherein:
the thermal conductive layer is in contact with and at least partly covers at least one of an inner surface of the case and an outer surface of the case, the inner surface of the case facing the capacitor element, the outer surface of the case being opposite to the inner surface of the case, and
a thermal conductivity λ_{L} of the thermal conductive layer in a thickness direction is greater than or equal to a thermal conductivity λ₁ of the first heat radiation layer in a thickness direction.
